(19) United States
(12) Patent Application Publication
(10) Pub. No.: US 2002/0181877 A1
(43) Pub. Date: Dec. 5, 2002

(54) Integrated one-dimensional mode-matching method between round and elliptical waveguide modes

(76) Inventor: Timothy Edwin Van Eck, Los Altos, CA (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/120,143

(22) Filed: Apr. 11, 2002

Related U.S. Application Data
(60) Provisional application No. 60/282,874, filed on Apr. 11, 2001.

(51) Int. Cl. G02B 6/30; G02B 6/26

(52) U.S. Cl. 385/49; 385/50; 385/28

(57) ABSTRACT

A method and integrated optical mode transform device is given whereby an optical waveguide positioned on a support substrate for receiving light from a optical fiber passing through a mode-matcher converting light from one mode to another to minimize optical loss.

This application is based on Provisional Application No. 60/282,874 filed Apr. 11, 2001.

### FIELD OF THE INVENTION

The present invention relates to optical waveguides and transmission in devices such as, for example, lasers and polymer modulators. More particularly this invention pertains improvements in efficiency and avoiding mode mismatch. Specifically, this invention relates to devices and methods of resolving one-dimensional mode-mismatch between round and elliptical waveguide modes.

### BACKGROUND OF THE INVENTION

There are several method used to optimize performance of integrated optical waveguides such as, for example, lasers and polymer waveguides. Frequently, the optical mode of light in a waveguide is elliptical in shape while standard optical fibers have round optical modes. The difference in size and dimension between such integrated optical waveguides and optical fibers cause mode mismatch and, thus, inefficiencies in such electro-optic devices.

Some types of integrated optical waveguides such as lasers and polymer modulator waveguides obtain optimal performance when the optical mode of the light in the waveguide is elliptical in shape but, as noted earlier, standard optical fibers have round optical modes. The difference in size and dimension between such integrated optical waveguides and optical fibers causes mode match loss equal to 10×log₁₀ (T), in dB units, where:

$$T = \frac{4}{( \frac{{d}_{f}}{{d}_{a}} + \frac{{d}_{a}}{{d}_{f}} ) ( \frac{{d}_{f}}{{d}_{b}} + \frac{{d}_{b}}{{d}_{f}} )}$$

where d_{f} is the diameter of the fiber mode, dₐ is the major axis diameter of the elliptical waveguide mode, and d_{b} is the minor axis diameter of the elliptical waveguide mode. For example, for a fiber with d_{f}=9 microns, and an integrated optical waveguide with dₐ=10 microns and d_{b}=2 microns, the optical loss from mode mismatch would be 3.8 dB, but if the minor axis diameter could be increased to d_{b}=8 microns, the optical loss from mode mismatch would be reduced to 0.1 dB.

The problem of mode-mismatch has been recognized but not fully resolved. One known method is to reduce the size of the optical beam from a standard optical fiber (e.g., 9 microns) by grinding a cylindrical lens onto the fiber tip, which focuses the light from the fiber in one dimension only, matching it more closely with the smaller of the two optical beam dimensions of the polymer waveguide, provided the polymer waveguide is placed at the focal length of the cylindrical lens.

Another known method is to monolithically integrate a structure, called a spot size transformer, on the same substrate as the polymer waveguide, that adiabatically transforms the elliptical waveguide mode to a large round mode matching the optical mode of a standard optical fiber. This method allows alignment of a large optical mode at the end of the waveguide substrate to another large optical mode at the tip of a standard fiber.

For the cylindrical lens on the fiber, the principle performance problem is that the mode matching is achieved by making a large spot small, rather than by making a small spot large, so the alignment tolerance between the lensed fiber and the waveguide is very tight. The cylindrical lensed fiber also has the problem of the high cost of individually grinding each fiber to a cylindrical shape with tight tolerance.

For the integrated spot size transformer solution, one problem is that the spot sized transformer is a very complex structure, requiring patterning of both the in-plane shape and thickness of structures, and it requires novel fabrication processes, so it may be expensive and low-yield. Also, the materials making up the polymer waveguides are optimized for performance of the modulator, not the performance of fabrication of the spot size transformer, further increasing the complexity and cost of the method.

### SUMMARY OF THE INVENTION

The techniques and methods of this invention have been found to be useful whereby a one-dimensional mode-matching system can solve problems of mode-mismatch in waveguide-fiber and optic cable arrangements. By this invention optimal performance between waveguides and optical fibers is established.

It is an object of this invention to resolve dimensional mode-mismatch in waveguide and optical fiber systems.

It is a further object of this invention to establish a one-dimensional mode-matching system.

It is a yet a further object of this invention to transform small spot dimensions to a large spot dimensions on the same substrate as the integrated optical waveguide.

By this invention a structure is provided to transform a small spot dimension to a large spot dimension on the same substrate as the integrated optical waveguide. More importantly, in one preferred implementation of this invention, the transformance between the small spot dimension to the large spot dimension is self-aligned to the waveguide center, so alignment between fiber and the waveguide can be achieved, with loose tolerance

The structure that transforms a small spot dimension to a large spot dimension is integrated on the same substrate as the integrated optical waveguide, and in some implementations self-aligned to the waveguide center, so alignment between fiber and waveguide can be done between two large spots, with loose tolerance.

The structure of this invention that transform a small spot dimension to a large spot dimension is further capable of self-alignment allowing an automatic alignment of the mode matching structure to the optical waveguide.

Also, the structures described in this invention are simpler, thus less costly, than the prior art.

### DESCRIPTION OF THE DRAWINGS

FIG. 1 is a side view of the general mode-matching concept of this invention.

FIG. 2 is a side view of a one-dimensional beam expander with integrated one-dimensional index gradient lenses.

FIG. 3 is an example of process steps for fabricating integrated one-dimensional index gradient lenses.

### DETAILED DESCRIPTION OF THE INVENTION

The benefits and advantages of this invention waveguides are obtained by apparatus and method of reducing the difference in size and dimension between integrated optical waveguides and optical fibers.

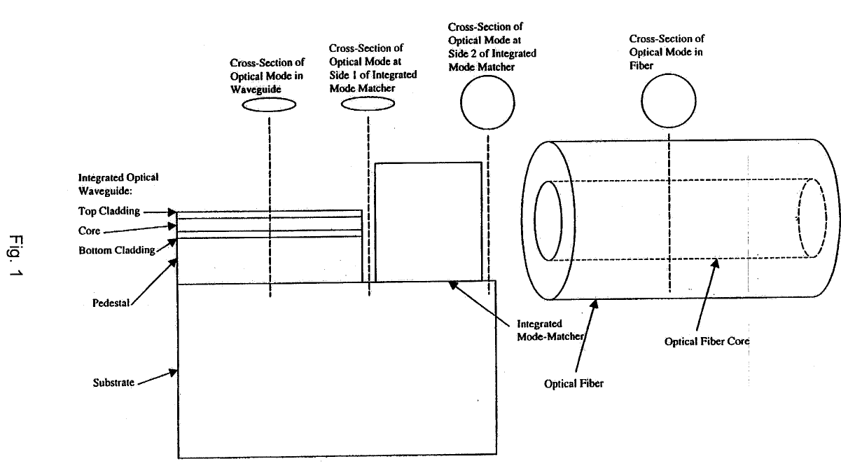

Many types of optical waveguides demonstrate optimum performance when the optical mode of the fiber optic path and the waveguide have approximately the same dimensions and shape. But since modulator waveguides and other types of integrated structures generally have optimal performance when the optical mode of the light in the waveguide is elliptical in shape which is seen in FIG. 1, the standard round optical fibers have a different modes. By reducing the difference in size and dimension between such integrated optical waveguides and optical fibers significant improvement can be achieved.

This invention is a method for making a mode-matcher that will transform light from the elliptical mode to the round mode. By the method of this invention the mode-matcher will transfer light from the round mode to the elliptical mode because the devices of this invention are or can be bi-directional. The mode matcher of this invention can be advantageously integrated on the same substrate as the optical waveguide, and create a large round mode registered to the waveguide substrate, which can then be aligned to the large round mode of an optical fiber, with loose alignment tolerance.

In FIG. 1 there is shown an integrated optical waveguide that has been fabricated on a substrate, with a core layer that confines light and cladding layers above and below it. A lateral confinement is also present (not shown). A cross section of the elliptical optical mode of the integrated optical waveguide is also shown.

A standard optical fiber is shown in FIG. 1 to the right of the integrated optical waveguide with a light-confining core in the center surrounded by a cladding. The large round optical mode is also shown in cross-section.

This invention addresses the problem in which one axis diameter of the integrated optical waveguide mode, such as the major axis diameter, is similar in size to the optical fiber mode diameter, and the other axis diameter, such as the minor axis diameter, is significantly dissimilar in size. Frequently the integrated optical waveguide is much smaller when compared to the to the optical fiber mode diameter, as illustrated in FIG. 1.

FIG. 1 also shows the integrated mode matcher, which can have one of several different implementations, which is itself fabricated on the same substrate as the waveguide, using compatible materials and fabrication processes, so it is self-aligned to the waveguide. When the elliptical waveguide mode enters the integrated mode matcher from the proper side (from the left side in FIG. 1), it is transformed into a large round mode very similar in size to the optical fiber mode, which exits on the opposite side. In this configuration, the mode mismatch with the optical fiber mode will be small.

The integrated mode matcher can be bidirectional, so that when an optical fiber mode entering from the proper side (from the right side in FIG. 1), it is transformed into an elliptical mode very similar in dimensions to the integrated optic waveguide. In this operation the mode mismatch with the integrated optical waveguide mode will be small.

Since the optical fiber mode is larger in one dimension than the integrated optic waveguide mode, it may be partially blocked by the substrate. This is conveniently resolved by elevating the integrated optical waveguide from the substrate by fabricating it on a pedestal, which is not usually a part of the optical structure of the integrated optical waveguide nor part of any related electrical circuit. The pedestal may be simply a uniform film of some neutral and compatible material that covers the substrate everywhere except where the integrated mode matcher is fabricated. In some implementations of this invention the pedestal forms part of the integrated mode matcher, as does a similar layer on top of the waveguide which can be called the top pedestal.

This invention includes any type of integrated mode matcher performing the function described above, namely that it will alter, for example expand, the size of the mode in one dimension, but may leave the mode size substantially unchanged in the other dimension.

However, a specific example will be illustrated and explained.

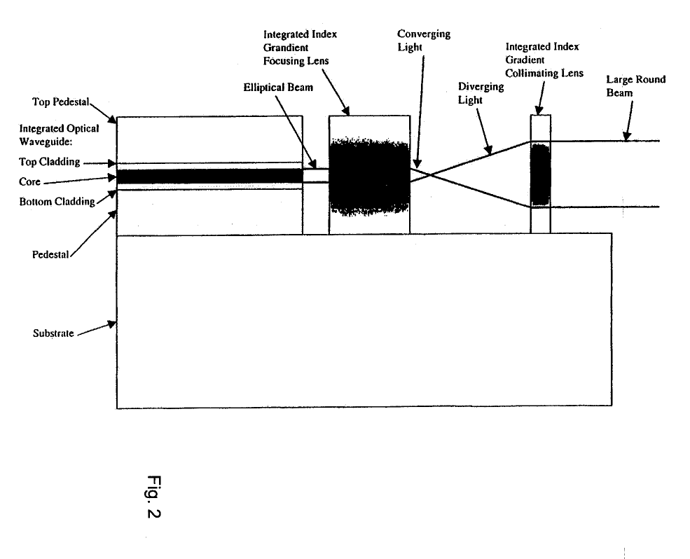

One implementation of an integrated one-dimensional mode matcher, in this case an integrated one-dimensional beam expander, is illustrated in FIG. 2. This implementation uses optical focusing elements that are fabricated on the same substrate as the waveguide, and have focusing power in only one dimension, such as the dimension of the minor axis of the elliptical waveguide mode. The first element focuses the beam in the dimension requiring enlargement, allowing divergence to the required size, and the second collimates the light after the required divergence. The elements have no focusing power in the other dimension, so they do not cause focusing, divergence, or collimation, but leave the beam size unchanged in one axis, such as the major axis of the elliptical waveguide mode. In this implementation the focusing power is provided by a quadratic index gradient with the maximum centered to intercept the center of the waveguide mode. The focusing power is proportional to the thickness of the focusing element, so the focusing lens is thicker and the collimating lens is thinner.

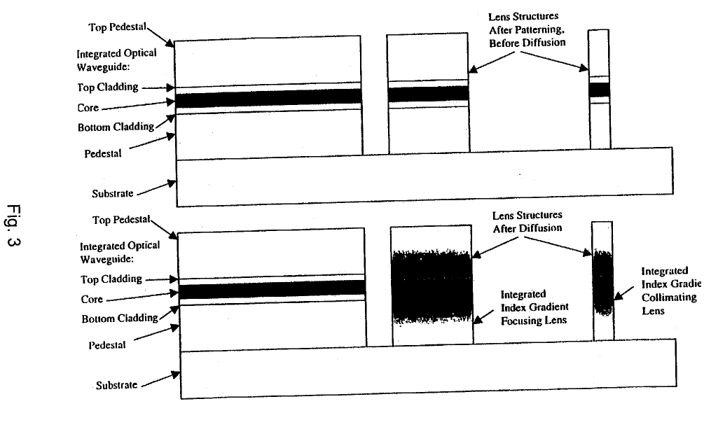

One method for fabricating such integrated gradient index lenses is illustrated in FIG. 3. In a first step (not illustrated), the waveguide layers are made on tope of the pedestal, then the top pedestal is fabricated on top of the waveguide layers. In the second step, the top pedestal, waveguide, and pedestal are selectively processed to cause diffusion of the dye material into the cladding layers and pedestal layers, by a selective process such as localized laser heating, or some other process. This results in a movement or distribution of the dye material. In a preferred embodiment the dye achieves an approximately quadratic distribution, thus an approximately quadratic distribution of the refractive index, centered in the same plane as the center of the waveguide core layer, thus centered in the same plane as the waveguide mode, as desired.

Alternatively, the selective dye diffusion can be done before the selective material etching. It may be possible to omit the focusing lens, if the minor axis diameter is small enough to cause adequate divergence because of light diffraction.

By this invention a reduction high optical loss occurring between a polymer waveguide mode, which is elliptical (e.g., 2 microns×10 microns), and a fiber mode, which is round (e.g., 9 microns×9 microns), can be specifically achieved. And the cost can be reduce the cost in doing so.

For some applications in RF distribution and frequency shifting, the gain an dynamic range of applications in RF distribution and frequency shifting, the gain and dynamic range of the RF link or frequency shifter increase (improve), and the noise figure decreases (improves), as the optical insertion loss decreases. For other applications, which might tend to be digital rather than RF in nature, the invention minimizes optical loss. This enables drop-in replacement for some incumbent technologies, which have higher electrical voltage and electrical power requirements and higher cost and also reducing the requirement for optical drive power and overall system power.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments.

What is claimed is:

1. An integrated optical mode transform device comprising an optical waveguide positioned on a support substrate for receiving light from a optical fiber passing through a mode-matcher converting the light from a substantially circular cross-section to a substantially elliptical cross-section.

2. The integrated optical mode transform device of claim 1 wherein the mode-matcher and waveguide are supported on the substrate.

3. The integrated optical mode transform device of claim 1 wherein fiber optics are positioned on said support substrate to receive transformed light from the mode-matcher.

4. The integrated optical mode transform device of claim 1 wherein the waveguide is elevated above the support substrate to receive transformed light from the mode-matcher.

5. An integrated optical mode transform device comprising an optical waveguide positioned on a support substrate communicating light which passes through a mode-matcher focusing the light to reduce mode mismatch with an optical fiber.

6. The integrated optical mode transform device of claim 5 wherein said waveguide, mode-matcher, and optical fiber and supported on said support substrate.

7. The integrated optical mode transform device of claim 5 wherein said mode-matcher is an optical focusing element having focusing power in one dimension.

8. A method for reducing optical loss between a waveguide and an optical fiber comprising passing light through a focusing mode-matcher to minimize optical loss.

9. The method of claim 8 wherein the light passing through said mode-matcher is focused in one dimension.
